(19) United States
(12) Patent Application Publication
(10) Pub. No.: US 2026/0172132 A1
(43) Pub. Date: Jun. 18, 2026

(54) Pluggable reference clock

(71) Applicant: MELLANOX TECHNOLOGIES, LTD., Yokneam (IL)

(72) Inventors: Nir Laufer, Zoran (IL); Dotan David Levi, Kiryat Motzkin (IL); Elad Mentovich, Tel Aviv (IL); Isabelle Cestier, Haifa (IL); Natan Manevich, Nesher (IL)

(21) Appl. No.: 18/985,098

(22) Filed: Dec. 18, 2024

(51) Int. Cl. H04J 3/06; H04L 7/00

(52) U.S. Cl. CPC H04J 3/0638; H04L 7/0008

(57) ABSTRACT

In one embodiment, a pluggable clock module apparatus includes a module housing, a physical interface to be plugged into a network port of a network device, and an oscillator disposed in the module housing, the oscillator being to generate a clock signal. In another embodiment, a system includes a network device including network ports and a pluggable clock module apparatus including a physical interface to be plugged into one of the network ports. The pluggable clock module apparatus is to provide the clock signal, or a network signal based on the clock signal, to the network device. The network device is to receive the clock signal, or recover the clock from the network signal, and to provide the clock signal to other devices in a network.

### FIELD OF THE DISCLOSURE

The present disclosure relates to computer systems, and in particular, but not exclusively to, clock synchronization.

### BACKGROUND

Network devices, such as switches, routers, network interface cards or controllers (NICs), and data processing units (DPUs) or smart NICs, provide and deliver precise timing to applications requiring accurate time and/or frequency and ensure proper operation and communication across networks. Oscillators play a crucial role in providing clock signals that govern the timing of various network operations, including data transmission, packet processing, and synchronization between devices.

In modern network architectures, high-quality clock signals are essential for maintaining accurate timekeeping, reducing jitter, and ensuring reliable data transfer. Network devices typically incorporate internal oscillators to generate these clock signals. These internal oscillators can vary in quality, stability, and precision depending on the specific requirements of the device and its intended application.

Synchronous Ethernet (SyncE) and Precision Time Protocol (PTP) are widely used technologies for distributing timing information across networks. These protocols allow network devices to synchronize their clocks and maintain a consistent time reference throughout the network infrastructure. This synchronization is particularly important in applications such as telecommunications, artificial intelligence (AI) clusters, datacenters, financial trading systems, and industrial control networks where precise timing is critical.

As networks continue to evolve and demand higher levels of time and frequency accuracy and stability, there is an ongoing interest in improving timing and synchronization capabilities. This includes exploring new ways to integrate high-quality timing sources into network devices and enhance the distribution of accurate clock signals across network infrastructures.

### OVERVIEW

There is provided in accordance with an embodiment of the present disclosure, a pluggable clock module apparatus, including a module housing, a physical interface to be plugged into a network port of a network device, and an oscillator disposed in the module housing, the oscillator being to generate a clock signal.

Further in accordance with an embodiment of the present disclosure the oscillator is to generate the clock signal without input from an external clock signal.

Still further, in accordance with an embodiment of the present disclosure the clock signal is receivable or recoverable by the network device.

Additionally in accordance with an embodiment of the present disclosure the pluggable clock module apparatus is to be powered via power received from the network device via the network port.

Moreover, in accordance with an embodiment of the present disclosure the oscillator is to act as primary reference clock.

Further in accordance with an embodiment of the present disclosure, the apparatus includes a physical layer (PHY) integrated circuit (IC), disposed in the module housing, to generate a network signal with symbols having a symbol rate based on a frequency of the clock signal generated by the oscillator, wherein the network signal is for receipt by the network device to recover the clock signal generated by the oscillator from the symbol rate of the network signal.

Still further in accordance with an embodiment of the present disclosure the PHY IC is to generate the network signal to provide the clock signal to the network device using Synchronous Ethernet (SyncE).

Additionally in accordance with an embodiment of the present disclosure, the apparatus includes a microprocessor is configured to manage and operate the pluggable clock module apparatus, and generate at least one of the following for sending to the network device a Sync-E message, a PTP message, an alarm.

Moreover, in accordance with an embodiment of the present disclosure, the apparatus includes a memory storing an inventory, which provides device-specific data about the pluggable clock module apparatus, wherein the data is usable by the network device during discovery of the pluggable clock module apparatus by the network device.

Further in accordance with an embodiment of the present disclosure the physical interface includes a plurality of pins, and wherein the oscillator is to output the clock signal to one of the pins for receipt by the network device via the network port.

Still further in accordance with an embodiment of the present disclosure, the apparatus includes a clock-out interface to connect a clock cable to a clock-in interface of the network device, wherein the oscillator is to receive power via the network port of the network device and provide the clock signal to the network device from the clock-out interface via the clock cable to the clock-in interface of the network device.

Additionally in accordance with an embodiment of the present disclosure the oscillator is selected from the group consisting of an atomic clock, a quartz oscillator, an Oven Controlled Crystal Oscillator (OCXO), a Temperature Compensated Crystal Oscillator (TCXO), and a microelectromechanical systems (MEMS) oscillator.

Moreover, in accordance with an embodiment of the present disclosure the oscillator has a stability equal to, or greater than 100 parts per billion.

Further in accordance with an embodiment of the present disclosure the module housing and physical interface are formed as a form-factor pluggable module.

Still further in accordance with an embodiment of the present disclosure the module is a Quad SFP (QSFP) module or an Octal SFP (OSFP) module.

Additionally in accordance with an embodiment of the present disclosure the network device is a network switch or a network interface card (NIC) or a data processing unit (DPU).

There is also provided in accordance with another embodiment of the present disclosure, a system, including a network device including network ports, and a pluggable clock module apparatus including a physical interface to be plugged into one of the network ports, wherein the pluggable clock module apparatus includes a module housing, and an oscillator to generate a clock signal, the pluggable clock module apparatus is to provide the clock signal, or a network signal based on the clock signal, to the network device, the network device is to receive the clock signal, or recover the clock from the network signal, and the network device is to provide the clock signal to other devices in a network.

Moreover, in accordance with an embodiment of the present disclosure the oscillator of the pluggable clock module apparatus has a higher stability of any oscillator included in the network device.

Further in accordance with an embodiment of the present disclosure the network device is to provide the clock signal to the other devices in the network using Synchronous Ethernet (SyncE) or Precision Time Protocol (PTP).

Still further in accordance with an embodiment of the present disclosure the other devices in the network include an artificial intelligence (AI) cluster of graphics processing units (GPUs) and/or central processing units (CPU).

There is also provided in accordance with still another embodiment of the present disclosure, a method, including plugging a pluggable clock module apparatus into a network port of a network device, receiving power from the network device via the network port to power the pluggable clock module apparatus, generating a clock signal by an oscillator of the pluggable clock module apparatus, and providing the clock signal, or a network signal based on the clock signal, to the network device.

Additionally in accordance with an embodiment of the present disclosure, the method includes receiving the clock signal, or recovering the clock signal from the network signal, by the network device.

Moreover, in accordance with an embodiment of the present disclosure, the method includes propagating, by the network device, the clock signal to other devices in a network.

Further in accordance with an embodiment of the present disclosure the other devices in the network include an artificial intelligence (AI) cluster of graphics processing units (GPUs) or central processing units (CPUs).

### BRIEF DESCRIPTION OF THE DRAWINGS

The present disclosure will be understood from the following detailed description, taken in conjunction with the drawings in which:

FIG. 1 is a schematic view of a pluggable clock module apparatus constructed and operative in accordance with an embodiment of the present disclosure;

FIG. 2 is a schematic view of a computer system showing clock signal distribution and network connectivity, in accordance with an embodiment of the present disclosure;

FIG. 3 is a flowchart including steps in a method of operation of the pluggable clock module apparatus of FIG. 1 in accordance with an embodiment of the present disclosure; and

FIG. 4 is a block diagram that schematically illustrates a computing system, e.g., a data center or a High-Performance Computing (HPC) cluster, in accordance with an embodiment of the present disclosure.

### DESCRIPTION OF EXAMPLE EMBODIMENTS

### Overview of Example Embodiments

Embodiments of the present disclosure address challenges associated with providing high-quality clock signals in network devices. Network devices typically rely on internal oscillators for timing and synchronization, but these oscillators can vary in quality, stability, and precision. High-end oscillators that offer superior performance are often costly, power-hungry, and occupy significant space, making their integration into all network devices impractical.

Embodiments of the present disclosure address at least some of the above drawbacks by providing a pluggable clock module apparatus that houses a high-quality oscillator. The apparatus can be easily inserted into a network port of a device such as a switch, router, NIC, or DPU, providing a stable clock signal without permanently integrating the oscillator into the device. The pins of the module connect with the pins of the network port so that the module is supported by the network port and does not need to occupy space in a server rack or similar location.

The pluggable nature of the module allows for flexibility in deployment, enabling the use of high-end oscillators only when necessary for specific applications or network locations. The module receives power from the network device through the network port, eliminating the need for a separate power source for the module, and therefore the oscillator. The oscillator within the module generates a clock signal independently, without requiring input from an external clock or external clock source. This clock signal can be directly provided to the network device via the network port or embedded in a network signal generated by a physical layer (PHY) integrated circuit (IC) within the module. The network device can then recover the clock signal from the network signal and utilize this high-quality clock signal, potentially serving as a master clock for other devices in the network using protocols like Synchronous Ethernet (SyncE) or Precision Time Protocol (PTP).

By encapsulating the oscillator in a form-factor pluggable module, embodiments of the present disclosure overcome space constraints in the network device and allow for easy upgrades or replacements of the elements in the module. The module may include additional features such as a memory storing device-specific data for discovery purposes, and in some configurations, a separate clock-out interface for direct connection to the network device's clock-in interface via a clock cable connected between the module and the network device. This innovative approach provides network operators with a flexible, scalable solution for incorporating high-stability clock sources into their infrastructure, enhancing timing accuracy and synchronization across the network without the limitations associated with permanently integrated high-end oscillators.

The oscillator in the pluggable module may be selected from various types, including atomic clocks, (high-end) quartz oscillators (e.g., Oven Controlled Crystal Oscillator (OCXO) or Temperature Compensated Crystal Oscillator (TCXO)), or (high-end) microelectromechanical systems (MEMS) oscillators, depending on the specific requirements for stability and precision. The form-factor of the pluggable module may conform to industry-standard formats such as Quad Small Form-factor Pluggable (QSFP) or Octal Small Form-factor Pluggable (OSFP). Form-factor pluggable modules are commonly used in networking equipment to provide flexible and modular connectivity options. These modules typically support various types of network connections, including copper and fiber optic interfaces, and can be easily inserted or removed from network devices as needed.

### System Description

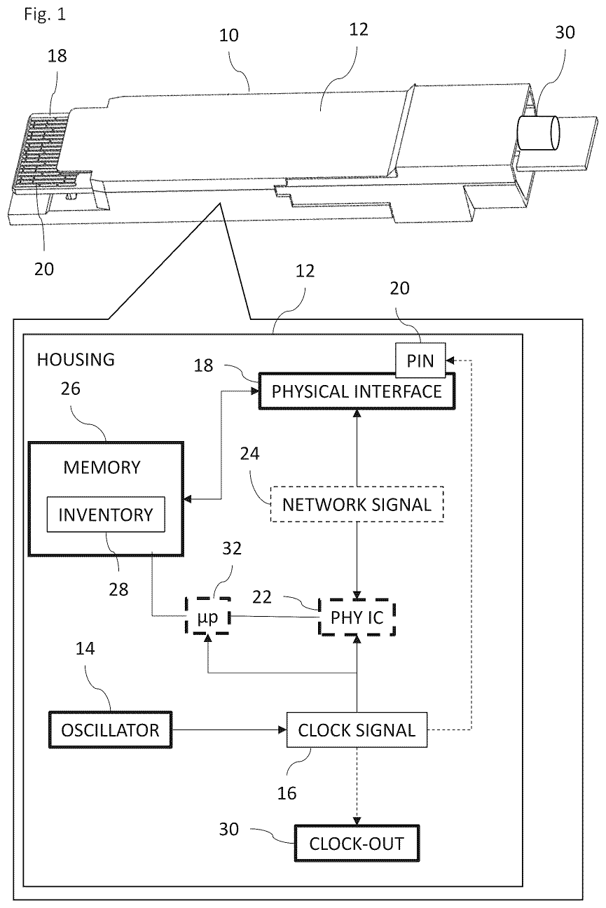

Referring to FIG. 1, a pluggable clock module apparatus 10 is illustrated. The apparatus 10 may comprise a module housing 12 that contains various components. In some embodiments, the module housing 12 may be designed to protect and enclose the internal components of the apparatus 10.

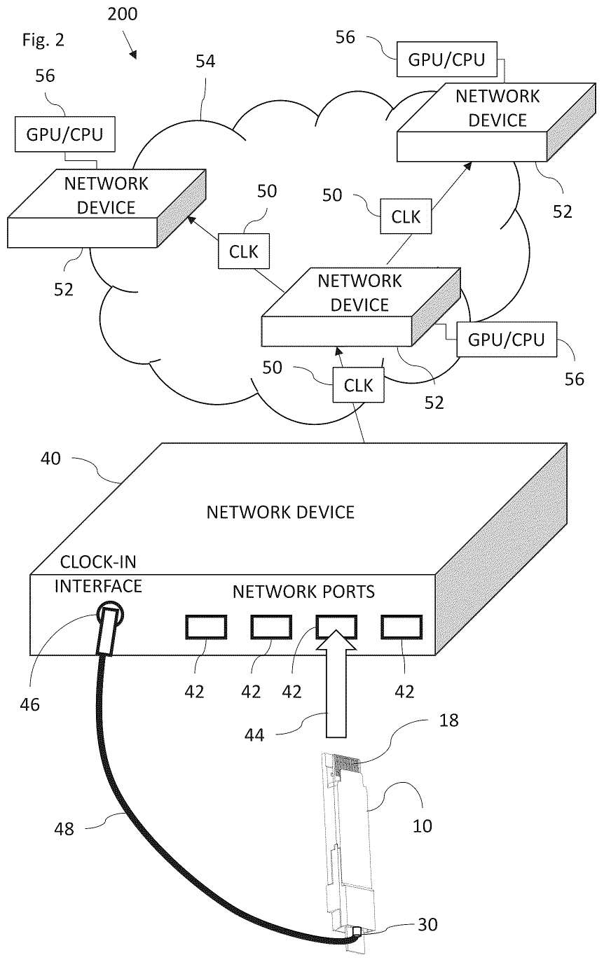

The pluggable clock module apparatus 10 includes a physical interface 18 that is configured to be plugged into a network port 42 (FIG. 2) of a network device 40 (FIG. 2). In some cases, the physical interface 18 may comprise a plurality of pins 20 for electrical connectivity with the network device 40. The pluggable clock module apparatus 10 is configured to be powered via electrical power received from the network device 40 via the network port 42 when plugged in to network port 42. This configuration may allow for a compact and efficient design, eliminating the need for a separate power source for the apparatus 10.

The pluggable clock module apparatus 10 includes an oscillator 14 disposed within the module housing 12. The oscillator 14 may be configured to generate a clock signal 16. In some embodiments, the oscillator 14 may be configured to generate the clock signal 16 without input from an external clock signal, thereby providing an independent and self-contained timing source for the apparatus 10. The oscillator 14 of the pluggable clock module apparatus 10 may have a higher stability than any oscillator included in the network device 40 to which the pluggable clock module apparatus 10 connects. This higher stability may allow the pluggable clock module apparatus 10 to serve as a primary reference clock for the network device 40 and potentially for other devices in a network 54 (FIG. 2). The process of generating clock signal 16 by the oscillator 14 of the pluggable clock module apparatus 10 may occur continuously while the apparatus 10 is powered. In some embodiments, the oscillator 14 may be designed to maintain a high level of stability and accuracy in its clock signal generation, even under varying environmental conditions such as temperature and humidity changes and vibrations. In some embodiments, the oscillator has a stability equal to, or greater than 100 parts per billion. The oscillator 14 in the pluggable clock module apparatus 10 may be selected from various types of high-stability oscillators such as an atomic clock, a quartz oscillator (e.g., Oven Controlled Crystal Oscillator (OCXO) or Temperature Compensated Crystal Oscillator (TCXO)), or a microelectromechanical systems (MEMS) oscillator. The stability of the OCXO is typically greater than, or equal to, 100 parts per billion (ppb) across the operational temperature with 1 ppb per degree Celsius.

In some embodiments, the clock signal 16 generated by the oscillator 14 may be receivable or recoverable by the network device 40. The clock signal 16 may be provided to the network device 40 through various means, such as via the physical interface 18 or through a dedicated clock-out interface 30, described in more detail below.

The pluggable clock module apparatus 10 may also include additional components to enhance its functionality. For example, the pluggable clock module apparatus 10 may also include a physical layer (PHY) integrated circuit (IC) 22 disposed in the module housing 12. The PHY IC 22 may be configured to generate a network signal 24 with symbols having a symbol rate based on the frequency of the clock signal 16 generated by the oscillator 14. This configuration may allow the network device to receive the network signal 24 and recover the clock signal 16 from the symbol rate of the network signal 24. In certain embodiments, the PHY IC 22 may be configured to generate the network signal 24 to provide the clock signal 16 to the network device using Synchronous Ethernet (SyncE). This approach may enable seamless integration of the pluggable clock module apparatus with existing network infrastructure that supports SyncE protocols. In some embodiments, the pluggable clock module apparatus 10 may include a MAC IC (not shown). In some embodiments, the pluggable clock module apparatus 10 may include a microprocessor 32, which may be configured to manage and operate the module, and generate one or more Sync-E or PTP messages, and/or alarms etc. for sending to the network device 40.

In some embodiments, the oscillator 14 may be configured to output the clock signal 16 to one of the pins 20 for receipt by the network device 40 via the network port 42. This direct clock signal output may provide an alternative method for the network device 40 to receive the timing information (e.g., the clock signal 16) generated by the oscillator 14.

As previously mentioned, the pluggable clock module apparatus 10 may be configured to provide the clock signal 16, or the network signal 24 based on the clock signal 16, to the network device 40 through various means. In some embodiments, the clock signal 16 may be provided directly through one of the pins 20 of the physical interface 18. In other cases, the network signal 24 generated by the PHY IC 22 may carry the timing information derived from the clock signal 16. This flexibility in providing timing information may allow the pluggable clock module apparatus 10 to interface with a wide range of network devices with different clock signal reception capabilities.

The pluggable clock module apparatus 10 may include a memory 26 storing an inventory 28. In some embodiments, the inventory 28 may be configured to provide device-specific data about the pluggable clock module apparatus 10 to the network device 40. This data may be usable by the network device 40 during a discovery process of the pluggable clock module apparatus 10. The memory 26 may be implemented as a read-only memory (ROM) or other suitable storage device.

The module housing 12 and physical interface 18 of the pluggable clock module apparatus 10 may be formed as a form-factor pluggable module. This configuration may allow for easy insertion and removal of the apparatus 10 from the network device 40 and different network devices. In some embodiments, the pluggable clock module apparatus 10 may be designed as a Quad Small Form-factor Pluggable (QSFP) module, which may support higher data rates and multiple channels. In other embodiments, the pluggable clock module apparatus 10 may be an Octal Small Form-factor Pluggable (OSFP) module, potentially offering even higher bandwidth capabilities. The form-factor pluggable design may enable the pluggable clock module apparatus 10 to be easily integrated into existing network infrastructure. In some cases, the QSFP or OSFP form factor may allow the apparatus 10 to be hot-swappable, meaning it can be inserted or removed from network device 40 without powering down network device 40. This feature may enhance the flexibility and maintainability of network systems incorporating the pluggable clock module apparatus 10.

Referring to FIG. 2, a system 200 for clock signal distribution and network connectivity is illustrated. The system 200 may comprise pluggable clock module apparatus 10, network device 40, and other network devices 52 interconnected via network connections in a network 54. In some embodiments, each network device 52 may be associated with a graphics processing unit (GPU) and/or a central processing unit (CPU) 56, for example disposed in a host device connected to network device 52 or disposed within network device 52.

The system 200 may include pluggable clock module apparatus 10 configured to be plugged into one of the network ports 42 of network device 40 via the network interface 18 of pluggable clock module apparatus 10 (arrow 44). The pluggable clock module apparatus 10 may be configured to establish a connection with the network device 40 for data transmission (e.g., to transfer the network signal 24 and inventory 28) and power delivery to pluggable clock module apparatus 10.

The pluggable clock module apparatus 10 may be configured to be powered via electrical power received from the network device 40 through the network port 42 and via physical interface 18. This configuration may allow for efficient integration of the pluggable clock module apparatus 10 into existing network infrastructure without requiring separate power sources.

In some embodiments, the network device 40 may include a clock-in interface 46. The clock-in interface 46 may be connected via a clock cable 48 to the clock-out interface 30 of the pluggable clock module apparatus 10.

The oscillator 14 within the pluggable clock module apparatus 10 may be configured to receive power via the network port 42 of the network device 40. In some cases, the oscillator 14 may be configured to provide clock signal 16 to the network device 40 via pin(s) 20 of the physical interface 18 to the network port 42. In some cases, the oscillator 14 may be configured to provide the clock signal 16 to the network device 40 from the clock-out interface 30 via the clock cable 48 to the clock-in interface 46 of the network device 40. The network device 40 may be configured to receive the network signal 24 or clock signal 16 via the network port 42 and to simultaneously receive the clock signal 16 via the clock-in interface 46 to measure the clock signal 16 for testing purposes, for example.

The system illustrated in FIG. 2 demonstrates how multiple network devices 52, each connected to a GPU/CPU 56 can be interconnected. This configuration may enable the distribution of clock signals across the network 54, potentially facilitating synchronized operations among the connected devices 52, 56.

Continuing with the description of FIG. 2, the oscillator 14 within the pluggable clock module apparatus 10 may act as a primary reference clock for the network 54. In some embodiments, this primary reference clock may be configured to drive a hardware clock (not shown) of the network device 40 and serve as the source of frequency in the network 54. The primary reference clock may have the highest stability of any oscillator in the network 50, and other devices 52, 56 may lock onto it.

The clock signal 16 generated by the oscillator 14 may be receivable or recoverable by the network device 40. In some cases, the network device 40 may be configured to receive the clock signal 16 directly through the network port 42 (e.g., via one of the pins 20 of the physical interface 18 of the pluggable clock module apparatus 10). In other embodiments, the network device 40 may be configured to recover the clock signal 16 from the network signal 24 transmitted by the pluggable clock module apparatus 10 using any suitable method, such as SyncE.

Upon receiving or recovering the clock signal, the network device 40 may be configured to utilize this high-stability clock signal 16 for its internal operations. The recovered or received clock signal 16 may be used by the network device 40 to update its own hardware clock. In some embodiments, the network device 40 may be configured to provide the clock signal 16 to other devices 52, 56 in the network 54. This distribution of the high-quality clock signal 16 may enable synchronized operations across multiple network components.

The network device 40 may employ various methods to provide the clock signal to other devices 52, 56 in the network 54. In some embodiments, the network device 40 may be configured to use Synchronous Ethernet (SyncE) to distribute the clock signal 16 to the other device in the network 54. SyncE may allow for the transmission of timing information over Ethernet physical layer connections, enabling precise synchronization between network elements.

Alternatively, or additionally, in some cases, the network device 40 may be configured to use Precision Time Protocol (PTP) to distribute a clock time to other devices in the network. PTP may provide a method for precise time synchronization in packet-based networks, allowing for sub-microsecond accuracy in some embodiments.

The propagation of the high-stability clock signal from the pluggable clock module apparatus 10 through the network device 40 to other devices 52, 56 in the network 54 may create a hierarchical timing structure. In this structure, the pluggable clock module apparatus 10 may be configured to serve as the primary reference, with the network device 40 acting as an intermediary distributor (e.g., boundary clock) of the timing information.

This arrangement may allow for flexible deployment of high-stability clock sources within the network 54. Network administrators may choose to install pluggable clock module apparatuses 10 with high-stability oscillators 14 at one or more strategic points in the network 54, ensuring that critical timing information is available where needed without requiring every device to have its own high-end oscillator 14.

Continuing with the description of FIG. 2, the network device 40 may be implemented as various types of network equipment. In some embodiments, the network device 40 may be a network switch, facilitating the connection and data transfer between multiple devices in the network 54. In other cases, the network device 40 may be a network interface card (NIC), providing network connectivity for a computer or server. Alternatively, the network device 40 may be implemented as a data processing unit (DPU), which may combine networking capabilities with computational resources.

The propagation of the clock signal 16 across the network 54 may support synchronized operations among connected devices, including the GPU/CPU 56 units shown in FIG. 2. In some embodiments, this synchronization may be particularly beneficial for applications requiring precise timing coordination, such as distributed computing tasks or real-time data processing.

In certain embodiments, the other devices in the network receiving the propagated clock signal may include an artificial intelligence (AI) cluster of graphics processing units (GPUs) and/or central processing units (CPUs) 56. The high-stability clock signal originating from the pluggable clock module apparatus 10 and distributed through the network device 40 to the graphics processing units (GPUs) and/or central processing units (CPUs) 56 may enable the AI cluster to maintain precise synchronization, potentially enhancing the performance and efficiency of AI workloads.

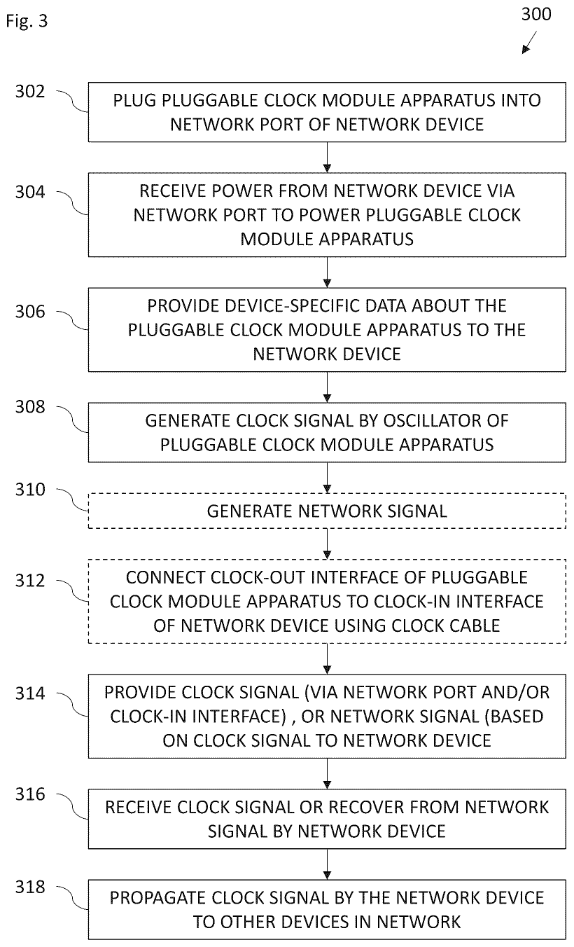

Referring to FIG. 3, a flowchart 300 including steps in a method for operating pluggable clock module apparatus 10 with network device 40 is illustrated. The method 300 may comprise several steps that outline the process of connecting, powering, and utilizing the pluggable clock module apparatus 10.

In some embodiments, the method 300 may begin with step 302, where the pluggable clock module apparatus 10 is plugged into network port 42 of network device 40. This step may involve physically inserting the physical interface 18 of the pluggable clock module apparatus 10 into the network port 42 of the network device 40.

Following the connection, in step 304, the pluggable clock module apparatus may receive power from the network device 40 via the network port 42. This configuration may allow the pluggable clock module apparatus 10 to operate without requiring a separate power source, enhancing its portability and ease of integration.

Step 306 of the method 300 may include providing device-specific data about the pluggable clock module apparatus 10 to the network device 40. In some cases, this data may be stored in the memory 26 of the pluggable clock module apparatus 10 as part of inventory 28. The network device 40 may use this information during the discovery process of the pluggable clock module apparatus 10.

In step 308, clock signal 16 may be generated by oscillator 14 of the pluggable clock module apparatus 10. The oscillator 14 may generate clock signal 16 without input from an external clock source, providing an independent timing reference for the system 200.

In some embodiments, following the generation of the clock signal 16, step 310 includes generating network signal 24. In some embodiments, the network signal 24 may be based on the clock signal 16 generated in step 308. The generation of the network signal 24 may be performed by PHY IC 22 within the pluggable clock module apparatus 10.

In some embodiments, step 312 includes connecting the clock-out interface 30 of the pluggable clock module apparatus 10 to the clock-in interface 46 of the network device 40 using clock cable 48. This step may provide an alternative path for clock signal transmission, in addition to the network port connection. Step 312 may be performed before step 302 or after step 302 but prior to any of steps 304-310. Similarly, step 312 may be performed after the clock signal has already been provided by pluggable clock module apparatus 10.

In step 314, either the clock signal 16 and/or the network signal 24 are provided to the network device 40. The clock signal 16 may be provided via the network port 42 and/or clock-in interface 46 (if clock cable 48 is connected from clock-out interface 30 to clock-in interface 46). This flexibility in signal provision may allow the pluggable clock module apparatus 10 to accommodate different network device configurations and requirements. In some embodiments, the clock signal 16 or network signal 24 is provided via network port 42 until pluggable clock module apparatus 10 is connected to network device 40 via clock cable 48 and then the clock signal 16 may be provided via clock-in interface 46.

In step 316, the network device 40 receives the clock signal 16, or recovers the clock signal 16 from the network signal 24. In cases where the network signal 24 is provided, the network device 40 may use techniques such as Synchronous Ethernet (SyncE) to recover the clock signal 16 from the received network signal 24.

In step 318, the network device 40 may propagate its clock time and/or frequency to other devices 52, 56 in the network 54 using any suitable method, such as SyncE and/or PTP. This propagation may enable synchronized operations across multiple network components, potentially including artificial intelligence (AI) clusters of graphics processing units (GPUs) or central processing units (CPUs) 56.

The flowchart 300 illustrates a process that integrates the pluggable clock module apparatus 10 into a network environment, emphasizing the generation and distribution of a clock signal. By following these steps, the pluggable clock module apparatus 10 may serve as a source of high-quality timing information for the entire network 54, potentially enhancing the performance and synchronization of connected devices 52, 56.

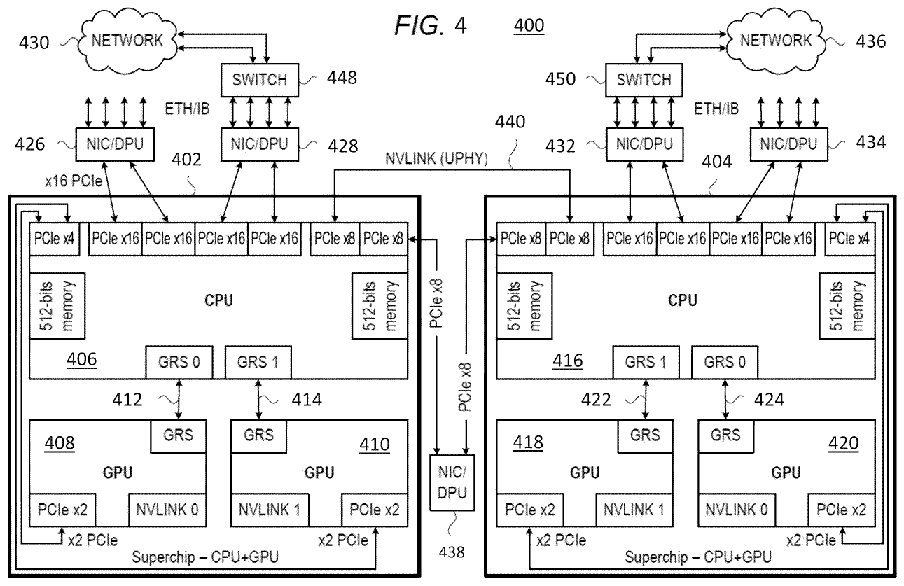

Reference is now made to FIG. 4, which is a block diagram that schematically illustrates a computing system 400, e.g., a data center or a High-Performance Computing (HPC) cluster, in accordance with an embodiment of the present disclosure. The network devices 40, 52 described herein above with reference to FIGS. 1-3 may be included in system 400 as one of the NICs, DPUs or switches of system 400. The GPUs/CPUs 56 described herein may also be included in the system 400 as one of the GPUs/CPUs of system 400.

System 400 comprises a plurality of subsystems, e.g. multiple processing devices coupled to each other, multiple network devices, and multiple networks, according to at least one embodiment. Computing system 400 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 400 and to one or more external networks 430, 436. In the present example, system 400 comprises a packet switch 448 that connects NIC/DPU 428 to network 430, and a packet switch 450 that connects NIC/DPU 432 to network 436.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 400 can include one or more CPUs and one or more GPUs.

FIG. 4 also demonstrates an example architecture of a multi-GPU architecture. As illustrated in the figure, computing system 400 includes a processing device 402 with a multi-GPU architecture. In particular, processing device 402 may be a system-on-chip and includes multiple subsystems such as a CPU 406, a GPU 408, and a GPU 410. CPU 406 can be coupled to GPU 408 via a die-to-die (D2D) or chip-to-chip (C2C) interconnect 412, such as a Ground-Referenced Signaling interconnect (GRS interconnect). CPU 406 can be coupled to GPU 410 via a D2D or C2C interconnect 414. CPU 406 can also couple to GPU 408 and GPU 410 via PCIe interconnects.

CPU 406 can be coupled to one or more NICs or DPUs, which are coupled to one or more networks. For example, as illustrated in FIG. 4, CPU 406 is coupled to a first NIC/DPU 426, which is coupled to a network 430. CPU 406 is also coupled to a second NIC/DPU 428, which is coupled to network 430 via switch 448. NIC/DPU 426 and NIC/DPU 428 can be coupled to network 430 over Ethernet (ETH), NVLINK or InfiniBand (IB) connections, for example.

Computing system 400 also includes a processing device 404 with a multi-GPU architecture. In particular, processing device 404 includes multiple subsystems including a CPU 416, a GPU 418, and a GPU 420. CPU 416 can be coupled to GPU 418 via a D2D or C2C interconnect 422. CPU 416 can be coupled to GPU 420 via a D2D or C2C interconnect 424. CPU 416 can also couple to GPU 418 and GPU 420 via PCIe interconnects. CPU 416 can be coupled to one or more NICs or DPUs, which are coupled to one or more networks. For example, as illustrated in FIG. 4, CPU 416 is coupled to a first NIC/DPU 432, which is coupled to a network 436. CPU 416 is also coupled to a second NIC/DPU 434, which is coupled to network 436 via switch 450. NIC/DPU 432 and NIC/DPU 434 can be coupled to network 436 over Ethernet (ETH), NVLINK or InfiniBand (IB) connections.

In at least one embodiment, processing device 402 and processing device 404 can communicate with each other via a NIC/DPU 438, such as over PCIe interconnects. Processing device 402 and processing device 404 can also communicate with each other over a high-bandwidth communication interconnect 440, such as an NVLink interconnect or other high-speed interconnects. The packet switches in FIG. 4 may comprise, for example, Nvidia Quantum-2 switches. The NICs/DPUs in the figure may comprise, for example, Nvidia Bluefield DPUs.

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A pluggable clock module apparatus, comprising:
a module housing;
a physical interface to be plugged into a network port of a network device; and
an oscillator disposed in the module housing, the oscillator being to generate a clock signal.

2. The apparatus according to claim 1, wherein the oscillator is to generate the clock signal without input from an external clock signal.

3. The apparatus according to claim 1, wherein the clock signal is receivable or recoverable by the network device.

4. The apparatus according to claim 1, wherein the pluggable clock module apparatus is to be powered via power received from the network device via the network port.

5. The apparatus according to claim 1, wherein the oscillator is to act as primary reference clock.

6. The apparatus according to claim 1, further comprising a physical layer (PHY) integrated circuit (IC), disposed in the module housing, to generate a network signal with symbols having a symbol rate based on a frequency of the clock signal generated by the oscillator, wherein the network signal is for receipt by the network device to recover the clock signal generated by the oscillator from the symbol rate of the network signal.

7. The apparatus according to claim 6, wherein the PHY IC is to generate the network signal to provide the clock signal to the network device using Synchronous Ethernet (SyncE).

8. The apparatus according to claim 1, further comprising a microprocessor is configured to manage and operate the pluggable clock module apparatus, and generate at least one of the following for sending to the network device: a Sync-E message; a PTP message, an alarm.

9. The apparatus according to claim 1, further comprising a memory storing an inventory, which provides device-specific data about the pluggable clock module apparatus, wherein the data is usable by the network device during discovery of the pluggable clock module apparatus by the network device.

10. The apparatus according to claim 1, wherein the physical interface comprises a plurality of pins, and wherein the oscillator is to output the clock signal to one of the pins for receipt by the network device via the network port.

11. The apparatus according to claim 1, further comprising a clock-out interface to connect a clock cable to a clock-in interface of the network device, wherein the oscillator is to receive power via the network port of the network device and provide the clock signal to the network device from the clock-out interface via the clock cable to the clock-in interface of the network device.

12. The apparatus according to claim 1, wherein the oscillator is selected from the group consisting of: an atomic clock; a quartz oscillator; an Oven Controlled Crystal Oscillator (OCXO); a Temperature Compensated Crystal Oscillator (TCXO); and a microelectromechanical systems (MEMS) oscillator.

13. The apparatus according to claim 1, wherein the oscillator has a stability equal to, or greater than 100 parts per billion.

14. The apparatus according to claim 1, wherein the module housing and physical interface are formed as a form-factor pluggable module.

15. The apparatus according to claim 14, wherein the module is a Quad SFP (QSFP) module or an Octal SFP (OSFP) module.

16. The apparatus according to claim 1, wherein the network device is a network switch or a network interface card (NIC) or a data processing unit (DPU).

17. A system, comprising:
a network device including network ports; and
a pluggable clock module apparatus including a physical interface to be plugged into one of the network ports, wherein:
the pluggable clock module apparatus includes a module housing, and an oscillator to generate a clock signal;
the pluggable clock module apparatus is to provide the clock signal, or a network signal based on the clock signal, to the network device;
the network device is to receive the clock signal, or recover the clock from the network signal; and
the network device is to provide the clock signal to other devices in a network.

18. The system according to claim 17, wherein the oscillator of the pluggable clock module apparatus has a higher stability of any oscillator included in the network device.

19. The system according to claim 17, wherein the network device is to provide the clock signal to the other devices in the network using Synchronous Ethernet (SyncE) or Precision Time Protocol (PTP).

20. The system according to claim 17, wherein the other devices in the network include an artificial intelligence (AI) cluster of graphics processing units (GPUs) and/or central processing units (CPU).

21. A method, comprising:
plugging a pluggable clock module apparatus into a network port of a network device;
receiving power from the network device via the network port to power the pluggable clock module apparatus;
generating a clock signal by an oscillator of the pluggable clock module apparatus; and
providing the clock signal, or a network signal based on the clock signal, to the network device.

22. The method according to claim 21, further comprising receiving the clock signal, or recovering the clock signal from the network signal, by the network device.

23. The method according to claim 22, further comprising propagating, by the network device, the clock signal to other devices in a network.

24. The method according to claim 23, wherein the other devices in the network include an artificial intelligence (AI) cluster of graphics processing units (GPUs) or central processing units (CPUs).
